(19) United States
(12) Patent Application Publication
(10) Pub. No.: US 2003/0236996 A1
(43) Pub. Date: Dec. 25, 2003

(54) Security objects controlling timed access to resources

(75) Inventors: Maria Azua Himmel, Yorktown Heights, NY (US); Herman Rodriguez, Austin, TX (US); Newton James Smith JR., Austin, TX (US); Clifford Jay Spinac, Austin, TX (US)

Correspondence Address: BIGGERS & OHANIAN, PLLC, 5 SCARLET RIDGE, AUSTIN, TX, 78737, US

(73) Assignee: INTERNATIONAL BUSINESS MACHINES CORPORATION, ARMONK, NY

(21) Appl. No.: 10/179,346

(22) Filed: Jun. 24, 2002

(51) Int. Cl. H04L 9/00

(52) U.S. Cl. 713/200

(57) ABSTRACT

Temporal control of access to a resource including creating a security object in dependence upon user-selected temporal security control data types, the security object comprising temporal security control data and at least one security method; receiving a request for access to the resource; receiving temporal security request data; and determining access to the resource in dependence upon the temporal security control data and the temporal security request data. Embodiments include storing in the security object a resource identification for the resource; storing in the security object user-selected temporal security control data types; and storing in the security object temporal security control data for each user-selected temporal security control data type. Some embodiments grant access to resources if a maximum allowable number of invocations is greater than a count of invocations. Some embodiments grant access if the time when a security object is invoked is within a validity period.

### BACKGROUND OF THE INVENTION

1. Field of the Invention

The-present invention relates to data processing methods, apparatus, systems, and computer program products therefor, and more particularly to methods, apparatus, systems, and computer program products in support of securing valid authentication and authorization for access to computer resources and other items.

2. Description of Related Art

Computer and network security systems generally secure resources by use of such temporal security control data as user identifications and passwords. Typically, however, the validity of such temporal security control data is either perpetual or it terminates after a defined period of validity. Even termination after a defined validity period, however, is often avoidable upon user action, such as defining a new password in response to prompts from a security system to do so. It is generally also true that the scope of temporal protection available is set by the security system generally at the level of the operating system, or sometimes by specialized application programs that manage user security and access control, and is basically not amenable to manipulation by a user. Users, that is, are not empowered to determine whether time-related protections are to be invoked, or if so, which ones. In typical security systems today, there is no way for anyone, especially not a user, to change from validity periods to counts, for example, to secure access to a resource, without substantial redesign and recoding. There is no way in such systems for a user or anyone else to determine to use more than one kind of temporal security control data without substantial redesign and recoding. It would be beneficial, therefore, to have improved ways of choosing and using temporal security control data to secure resources through computer systems.

### SUMMARY OF THE INVENTION

Embodiments of the present invention include methods of temporal control of access to resources including creating a security object in dependence upon user-selected temporal security control data types, the security object comprising temporal security control data and at least one security method; receiving a request for access to the resource; receiving temporal security request data; and determining access to the resource in dependence upon the temporal security control data and the temporal security request data. Embodiments include storing in the security object a resource identification for the resource; storing in the security object user-selected temporal security control data types; and storing, in the security object, temporal security control data for each user-selected temporal security control data type.

Some embodiments grant access to resources if a maximum allowable number of invocations is greater than a count of invocations. Some embodiments grant access if the time when a security object is invoked is within a validity period. Some embodiments grant access only so long as a maximum allowable number of invocations of a security object is not met or exceeded during a validity period (a throttle period). Some embodiments grant access only so long as a minimum number of invocations of a security object is met or exceeded during a validity period (a threshold period).

In some methods of temporal control of access to a resource according to embodiments of the present invention, receiving a request for access to the resource comprises calling a security member method in a security object. In some embodiments, receiving a request for access to a resource includes identifying a security object that controls access to the resource. In some embodiments, a security object is identified by use of a Universal Resource Identifier (“URI”). In some embodiments a URI that identifies a security object does so by direct reference to the security object. In other embodiments, a URI identifies a security object indirectly by identifying a resource name used to identify the associated security object through a lookup in an access control table.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIGS. 1a, 1b, and 1c set forth block diagrams depicting alternative exemplary data processing architectures useful in various embodiments of the present invention.

FIG. 2 sets forth a data flow diagram depicting exemplary methods of controlling access to a resource, including creating a security object and receiving a request for access to a resource, and determining whether to grant access to the resource.

FIG. 3 sets forth a data flow diagram depicting an exemplary method of creating a security object.

FIG. 4 sets forth a class relations diagram including a security class and a temporal security control class.

FIG. 5 is a combination class and control flow diagram depicting an exemplary method of temporal control of access to a resource in which temporal security control data comprises a maximum allowable number of invocations of a security object.

FIG. 6 is a combination class and control flow diagram depicting an exemplary method of temporal control of access to a resource in which temporal security control data comprises a validity period for invocations of a security object.

FIG. 7 is a combination class and control flow diagram depicting an exemplary method of temporal control of access to a resource using a security object to establish a threshold of a required minimum number of invocations for a period of time.

FIG. 8 is a combination class and control flow diagram depicting a method of temporal control of access to a resource in which a security object establishes a throttle for a maximum number of invocations in a predetermined period of time.

FIG. 9 sets forth a data flow diagram depicting exemplary methods of receiving requests for access to resources.

### DETAILED DESCRIPTION OF EXEMPLARY EMBODIMENTS

Introduction

The present invention is described to a large extent in this specification in terms of methods for securing valid authentication and authorization for access to computer resources and other items. Persons skilled in the art, however, will recognize that any computer system that includes suitable programming means for operating in accordance with the disclosed methods also falls well within the scope of the present invention.

Suitable programming means include any means for directing a computer system to execute the steps of the method of the invention, including for example, systems comprised of processing units and arithmetic-logic circuits coupled to computer memory, which systems have the capability of storing in computer memory, which computer memory includes electronic circuits configured to store data and program instructions—programmed steps of the method of the invention for execution by a processing unit. The invention also may be embodied in a computer program product and stored on a diskette or other recording medium for use with any suitable data processing system.

Embodiments of a computer program product may be implemented by use of any recording medium for machine-readable information, including magnetic media, optical media, or other suitable media. Persons skilled in the art will immediately recognize that any computer system having suitable programming means will be capable of executing the steps of the method of the invention as embodied in a program product. Persons skilled in the art will recognize immediately that, although most of the exemplary embodiments described in this specification are oriented to software installed and executing on computer hardware, nevertheless, alternative embodiments implemented as firmware or as hardware are well within the scope of the present invention.

Definitions

In this specification, the terms “field,” “data element,” and “attribute,” unless the context indicates otherwise, generally are used as synonyms, referring to individual elements of digital data. Aggregates of data elements are referred to as “records” or “data structures.” Aggregates of records are referred to as “tables” or “files.” Aggregates of files or tables are referred to as “databases.” Complex data structures that include member methods, functions, or software routines as well as data elements are referred to as “classes.” Instances of classes are referred to as “objects” or “class objects.”

“Browser” means a web browser, a communications application for locating and displaying web pages. Browsers typically comprise a markup language interpreter, web page display routines, and an HTTP communications client. Typical browsers today can display text, graphics, audio and video. Browsers are operative in web-enabled devices, including wireless web-enabled devices. Browsers in wireless web-enabled devices often are downsized browsers called “microbrowsers.” Microbrowsers in wireless web-enabled devices often support markup languages other than HTML, including for example, WML, the Wireless Markup Language.

“CORBA” means the Common Object Request Broker Architecture, a standard for remote procedure invocation first published by the Object Management Group (“OMG”) in 1991. CORBA can be considered a kind of object-oriented way of making “RPCs” or remote procedure calls, although CORBA supports many features that do not exist in RPC as such. CORBA uses a declarative language, the Interface Definition Language (“IDL”), to describe an object's interface. Interface descriptions in IDL are compiled to generate ‘stubs’ for the client side and ‘skeletons’ on the server side. Using this generated code, remote method invocations effected in object-oriented programming languages such as C++ and Java look like invocations of local member methods in local objects. Whenever a client program, such as, for example, a C++ program, acquires an object reference, decoded from a stringified object reference, from a Naming Service, or as a result from another method invocation, an ORB creates a stub object. Since a stub object cannot exist without an object reference, and an object reference rarely exists outside a stub object, these two terms are often used synonymously. For the server side, a skeleton is generated by the IDL compiler. A developer derives from that skeleton and adds implementation; an object instance of such an implementation class is called a ‘servant.’ The generated skeleton receives requests from the ORB, unmarshalls communicated parameters and other data, and performs upcalls into the developer-provided code. This way, the object implementation also looks like a ‘normal’ class.

“CGI” means “Common Gateway Interface,” a standard technology for data communications of resources between web servers and web clients. More specifically, CGI provides a standard interface between servers and server-side ‘gateway’ programs which administer actual reads and writes of data to and from file systems and databases. The CGI interface typically sends data to gateway programs through environment variables or as data to be read by the gateway programs through their standard inputs. Gateway programs typically return data through standard output.

“Client device” refers to any device, any automated computing machinery, capable of requesting access to a resource. Examples of client devices are personal computers, internet-enabled special purpose devices, internet-capable personal digital assistants, wireless handheld devices of all kinds, garage door openers, home security computers, thumbprint locks on briefcases, web-enabled devices generally, and handheld devices including telephones, laptop computers, handheld radios, and others that will occur to those of skill in the art. Various embodiments of client devices are capable of asserting requests for access to resources via wired and/or wireless couplings for data communications. The use as a client device of any instrument capable of a request for access to a resource is well within the present invention.

A “communications application” is any data communications software capable of operating couplings for data communications, including email clients, browsers, special purpose data communications systems, as well as any client application capable of accepting data downloads (downloads of security objects or resources, for example) via hardwired communications channels such as, for example, a Universal Serial Bus or ‘USB,’ downloads through wired or wireless networks, and downloads through other means as will occur to those of skill in the art. In typical embodiments of the present invention, communications applications run on client devices.

“DCOM” means ‘Distributed Component Object Model,’ an extension of Microsoft's Component Object Model (“COM”) to support objects distributed across networks. DCOM is part of certain Microsoft operating systems, including Windows NT, and is available for other operating systems. DCOM serves the same purpose as IBM's DSOM protocol, which is a popular implementation of CORBA. Unlike CORBA, which runs on many operating systems, DCOM is currently implemented only for Windows.

“HTML” stands for ‘HyperText Markup Language,’ a standard markup language for displaying web pages on browsers.

“HTTP” stands for ‘HyperText Transport Protocol,’ the standard data communications protocol of the World Wide Web.

A “hyperlink,” also referred to as “link” or “web link,” is a reference to a resource name or network address which when invoked allows the named resource or network address to be accessed. More particularly in terms of the present invention, invoking a hyperlink implements a request for access to a resource. Often a hyperlink identifies a network address at which is stored a resource such as a web page or other document. As used here, “hyperlink” is a broader term than “HTML anchor element.”

Hyperlinks include links effected through anchors as well as URIs invoked through ‘back’ buttons on browsers, which do not involve anchors. Hyperlinks include URIs typed into address fields on browsers and invoked by a ‘Go’ button, also not involving anchors. In addition, although there is a natural tendency to think of hyperlinks as retrieving web pages, their use is broader than that. In fact, hyperlinks access “resources” generally available through hyperlinks including not only web pages but many other kinds of data and server-side script output, servlet output, CGI output, and so on.

“LAN” means local area network.

“Network” is used in this specification to mean any networked coupling for data communications among computers or computer systems. Examples of networks useful with the invention include intranets, extranets, internets, local area networks, wide area networks, and other network arrangements as will occur to those of skill in the art.

An “ORB” is a CORBA Object Request Broker.

“Resource” means any information or physical item access to which is controlled by security objects of the present invention. Resources often comprise information in a form capable of being identified by a URI or URL. In fact, the ‘R’ in ‘URI’ is ‘Resource.’ The most common kind of resource is a file, but resources include dynamically-generated query results, the output of CGI scripts, dynamic server pages, documents available in several languages, as well as physical objects such as garage doors, briefcases, and so on. It may sometimes be useful to think of a resource as similar to a file, but more general in nature. Files as resources include web pages, graphic image files, video clip files, audio clip files, and so on. As a practical matter, most HTTP resources are currently either files or server-side script output. Server side script output includes output from CGI programs, Java servlets, Active Server Pages, Java Server Pages, and so on.

“RMI,” or “Java RMI,” means ‘Remote Method Invocation,’ referring to a set of protocols that enable Java objects to communicate remotely with other Java objects. RMI's structure and operation is somewhat like CORBA's, with stubs and skeletons, and references to remotely located objects. In comparison with other remote invocations protocols such as CORBA and DCOM, however, RMI is relatively simple. RMI, however, works only with Java objects, while CORBA and DCOM are designed to support objects created in any language.

“Server” in this specification refers to a computer or device comprising automated computing machinery on a network that manages resources and requests for access to resources. A “security server” can be any server that manages access to resources by use of security objects according to the present invention. A “web server,” or “HTTP server,” in particular is a server that communicates with browsers by means of HTTP in order to manage and make available to networked computers documents in markup languages like HTML, digital objects, and other resources.

A “Servlet,” like an applet, is a program designed to be run from another program rather than directly from an operating system. “Servlets” in particular are designed to be run on servers from a conventional Java interface for servlets. Servlets are modules that extend request/response oriented servers, such as Java-enabled web servers. Java servlets are an alternative to CGI programs. The biggest difference between the two is that a Java servlet is persistent. Once a servlet is started, it stays in memory and can fulfill multiple requests. In contrast, a CGI program disappears after it has executed once, fulfilling only a single a request for each load and run. The persistence of Java servlets makes them generally faster than CGI because no time is spent on loading servlets for invocations after a first one.

A “URI” or “Universal Resource Identifier” is an identifier of a named object in any namespace accessible through a network. URIs are functional for any access scheme, including for example, the File Transfer Protocol or “FTP,” Gopher, and the web. A URI as used in typical embodiments of the present invention usually includes an internet protocol address, or a domain name that resolves to an internet protocol address, identifying a location where a resource, particularly a web page, a CGI script, or a servlet, is located on a network, usually the Internet. URIs directed to particular resources, such as particular HTML files or servlets, typically include a path name or file name locating and identifying a particular resource in a file system coupled through a server to a network. To the extent that a particular resource, such as a CGI file or a servlet, is executable, for example to store or retrieve data, a URI often includes query parameters, or data to be stored, in the form of data encoded into the URI. Such parameters or data to be stored are referred to as ‘URI encoded data.’

“URLs” or “Universal Resource Locators” comprise a kind of subset of URIs, wherein each URL resolves to a network address. That is, URIs and URLs are distinguished in that URIs identify named objects in namespaces, where the names may or may not resolve to addresses, while URLs do resolve to addresses. Although standards today are written on the basis of URIs, it is still common to such see web-related identifiers, of the kind used to associate web data locations with network addresses for data communications, referred to as “URLs.” This specification refers to such identifiers generally as URIs.

“WAN” means ‘wide area network.’ One example of a WAN is the Internet.

“World Wide Web,” or more simply “the web,” refers to a system of internet protocol (“IP”) servers that support specially formatted documents, documents formatted in markup languages such as HTML, XML (eXtensible Markup Language), WML (Wireless Markup Language), or HDML (Handheld Device Markup Language). The term “Web” is used in this specification also to refer to any server or connected group or interconnected groups of servers that implement a hyperlinking protocol, such as HTTP or WAP (the ‘Wireless Access Protocol’), in support of URIs and documents in markup languages, regardless of whether such servers or groups of servers are coupled to the World Wide Web as such.

### DETAILED DESCRIPTION

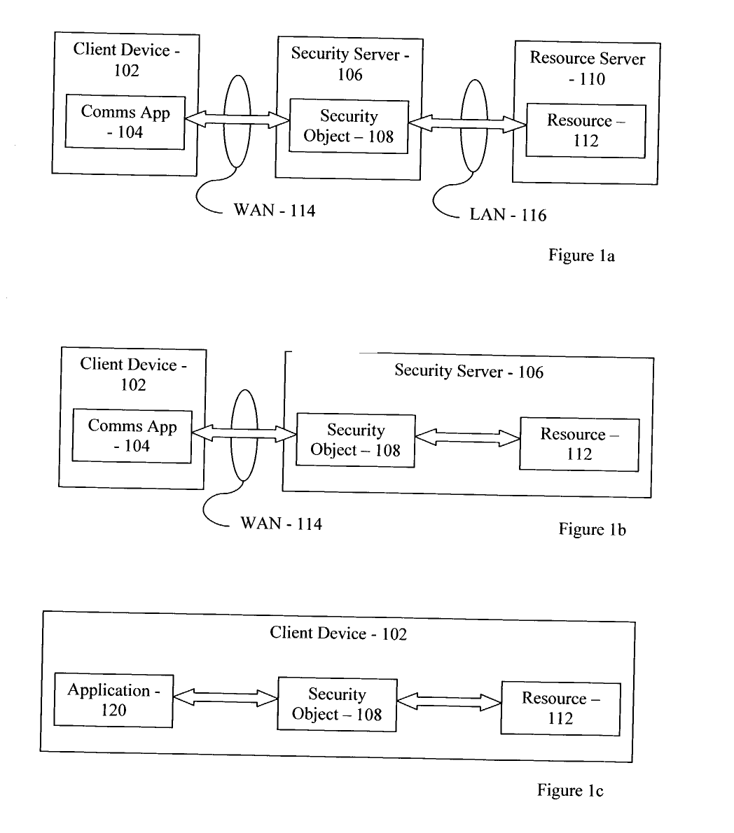

Embodiments of the present invention provide security objects for improving the administration of controlling access to secured resources. FIGS. 1a, 1b, and 1c set forth block diagrams depicting alternative exemplary data processing architectures useful in various embodiments of the present invention.

As illustrated in FIG. 1a, some embodiments of the present invention deploy security objects (108) in security servers (106) coupled for data communications through LANs (116) to resource servers (110) upon which resources (112) are stored. Such embodiments typically are coupled for data communications to client devices (102) through networks such as WANs (114) or LANs (116). Data communications between client devices and security servers in such architectures are typically administered by communications applications (104), including, for example, browsers. WANs include internets and in particular the World Wide Web. Client devices (102) are defined in detail above and include any automated computing machinery capable of accepting user inputs through a user interface and carrying out data communications with a security server. A “security server” is any server that manages access to resources by use of security objects according to the present invention.

As illustrated in FIG. 1b, some embodiments of the present invention deploy security objects (108) in security servers (106) upon which are stored secured resources (112). The architecture of FIG. 1b illustrates that resources can be stored on the same server that secures access to the resources. In all this discussion, the term ‘security server’ refers to a server that manages access to resources by use of security objects according to the present invention. There is no limitation that a ‘security server’ as the term is used in this disclosure must provide other security services, or indeed that a security server must provide any security services whatsoever, other than managing access to resources through security objects. FIGS. 1a and 1b show security objects deployed in or upon security servers, but having security objects deployed upon it is not a requirement for a server to be considered a security server within the usage of this disclosure. Security objects may be deployed anywhere on a network or on client devices. If a server manages access to resources by use of security objects, regardless where the security objects are located, then that server is considered a ‘security server’ in the terminology of this disclosure. Some ‘security servers’ of the present invention, as described in more detail below, are ordinary web servers modified somewhat to support lookups in access control tables. Many ‘security servers’ of the present invention, however, are ordinary unmodified web servers or Java web servers, designated as ‘security servers’ only because they manage access to resources by use of security objects, security objects which may or may not be installed upon those same servers.

As shown in FIG. 1c, some embodiments deploy security objects (108) in client devices (102) which themselves also contain both the applications software (120) concerned with accessing the resources and also the resources (112) themselves. This architecture includes devices in which a security object may be created on a more powerful machine and then downloaded to a less powerful machine. The less powerful machine then often is associated one-to-one with a single resource, or is used to secure a relatively small number of resources. One example of this kind of embodiment includes a garage door opener in which a security application program (120) is implemented as an assembly language program on a tiny microprocessor or microcontroller and the secured resource is a motor that operates a garage door. Another example is a briefcase fitted with a microprocessor or microcontroller, a fingerprint reader, and a USB port through which is downloaded a security object that controls access to a resource, an electromechanical lock on the briefcase.

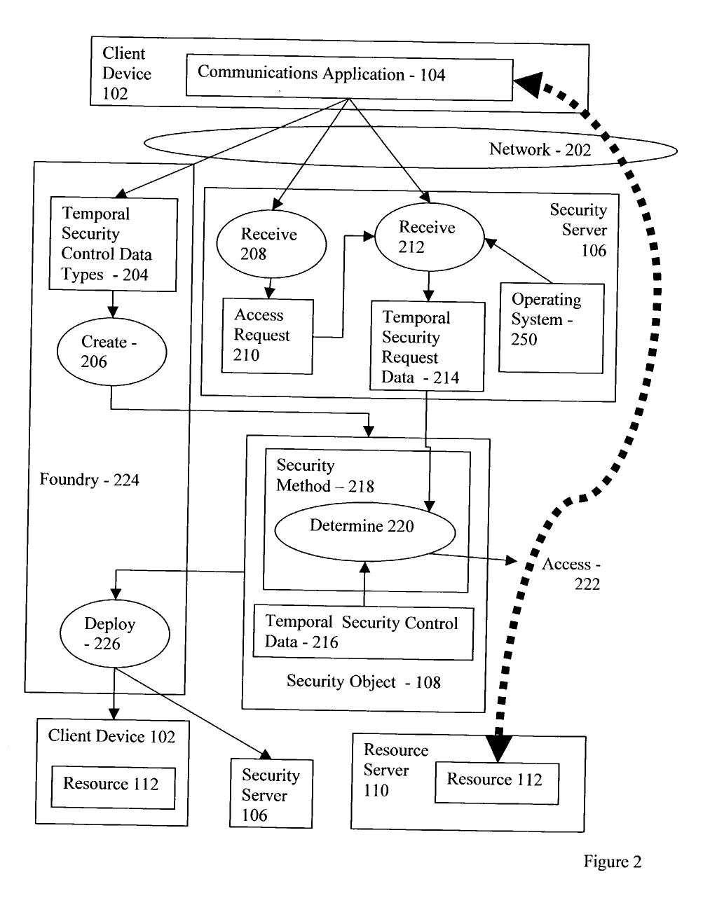

FIG. 2 sets forth a data flow diagram depicting an exemplary method of controlling access to a resource (112). The method of FIG. 2 includes creating (206) a security object (108) in dependence upon user-selected temporal security control data types (204), the security object comprising temporal security control data (216). In this disclosure, the application programs that administer the creation of security objects are called ‘foundries.’ In typical embodiments according to FIG. 2, a foundry (224) prompts a user through a user interface displayed on a client device (102) to select one or more user-selected temporal security control data types (204) through, for example, use of a menu similar to this one:

Please select a temporal security control data type:

1. Maximum Number of Invocations

2. Validity Period

3. Throttle

4. Threshold

Your selection (1-4): ______

The foundry (224) creates (206) a security object (108) in dependence upon a user's selections of temporal security control data types in the sense that the foundry aggregates or associates by reference, in or with the security object, temporal security control data types according to the user's selection. If, for example, the user selects menu item 1 for a Maximum Number of Invocations, the foundry causes a temporal security control data type to be included in the security object that is valid only for a maximum number of invocations. (‘Invocation’ refers to one instance of receiving in a security object a request for access to a resource.) If the user selects menu item 2 for a Validity Period, the foundry causes a temporal security control data type to be included in the security object that is valid for access to a resource only for a predetermined period of time. If the user selects menu item 3 for a Throttle, the foundry causes a temporal security control data type to be included in the security object that is valid only for a certain number of invocations during a predetermined period of time. If the user selects menu item 4 for a Threshold, the foundry causes a temporal security control data type to be included in the security object that is valid only so long as a user invokes it at least a minimum number of times during a predetermined period of time.

In addition to temporal security control data types, the use of non-temporal security control data types, although optional, is well within the scope of the present invention. Examples of non-temporal security control data include logon IDs, passwords, fingerprints, retinal scans, voiceprints, and so on, any kind of security control data amenable to administration by electronic digital computers. Here is an example of what a foundry's prompting menu can look like when the foundry supports both temporal and non-temporal security control data:

Please select a security control data type:

1. Maximum Number of Invocations

2. Validity Period

3. Throttle

4. Threshold

5. Logon ID

6. Password

7. Fingerprint

8. Voiceprint

Your selection (1-8): ______

In typical embodiments of the present invention, as shown in FIG. 2, a security object (108) includes at least one security method (218). In this disclosure, a ‘security method’ is an object oriented member method. A security method typically is a software routine called for validating or determining whether to grant access to a resource and, optionally, what level of authorization to grant. As discussed in more detail below, security methods can have various names depending on how the security object is implemented, ‘main( )’ for security objects to be invoked with Java commands, ‘security( )’ for servlets, and so on. These exemplary names are for clarity of explanation only, not for limitation. In many forms of security object, the name chosen for the security method is of no concern whatsoever.

Embodiments according to FIG. 2 include receiving (208) a request (210) for access to a resource (112). Receiving a request for access to a resource can be implemented as a call to a security method in a security object. A security object implemented in Java, for example, can have a main( ) method called by invocation of the security object itself, as in calling ‘java MySecurityObject,’ resulting in a call to MySecurityObject.main( ). Such call to main( ) in itself, in many embodiments, comprises receiving (208) a request for access to a resource secured by a security object.

The method of FIG. 2 includes receiving (212) temporal security request data (214). Security request data is whatever data is needed, that is, not already on hand, when a request for access to a resource is received. Security request data is used in conjunction with security control data to determine whether to grant access to a resource. To acquire security request data when a request for access is received, a security object's member security method (218) takes steps to acquire security request data. In typical security objects according to embodiments of the present invention, a security object has associated security control objects each of which includes a security control method for assessing validity of an access request. Receiving (212) temporal security request data (214) often comprises a security object member security method's either prompting for security request data, obtaining security request data from a computer operating system or from another application program, causing a security control object to prompt for security request data, or causing a security control object to obtain security request data from an operating system or from another application program. In the case of non-temporal security control data, it is common for a security object or its associated security control objects to prompt for such data as logon IDs, passwords, thumbprints, and so on. In the case of temporal security control data, including data such as counts of invocations, the current time when a invocation occurs, and so on, it more common for the security object or its associated security control objects to obtain such security request data from an operating system or from another application program.

The method of FIG. 2 includes determining (220) access (222) to the resource in dependence upon temporal security control data (216) and temporal security request data (214). More particularly, determining access means determining whether to grant access and, optionally, what kind of access is to be granted. Generally in this disclosure, whether to grant access to a particular user is referred to as ‘authentication,’ and the kind of access granted is referred to as ‘authorization level.’ Authorization levels include authorization to read a resource, authorization to write to a resource (which typically includes ‘edit’ authority and ‘delete’ authority), and authorization to execute a resource. ‘Execute’ can mean running an executable resource, or, for resources that are not executable, directory access to the resource, listing the resource on a directory listing, or listing the contents of a directory.

Determining whether to grant access in the case of temporal security control data typically includes determining whether security request data meets predetermined criteria established on the basis of security control data. Examples of such predetermined criteria include, for example, whether a current count of invocations is at least equal to a preset maximum, whether the time when an invocation occurs is within a preset validity period, and so on.

As an aid to understanding, a description is presented for the optional case of determining access on the basis of non-temporal security control data and non-temporal security request data. Determining whether to grant access based on non-temporal security control data typically includes determining whether security request data provided by a user in connection with a request for access to a resource matches corresponding temporal security control data. That is, in the example of a password, determining whether to grant access includes determining whether a password provided as security request data matches a password stored in aggregation with a security object as temporal security control data. In the example of a thumbprint, determining whether to grant access includes determining whether a thumbprint provided as security request data matches a thumbprint stored in aggregation with a security object as temporal security control data. And so on.

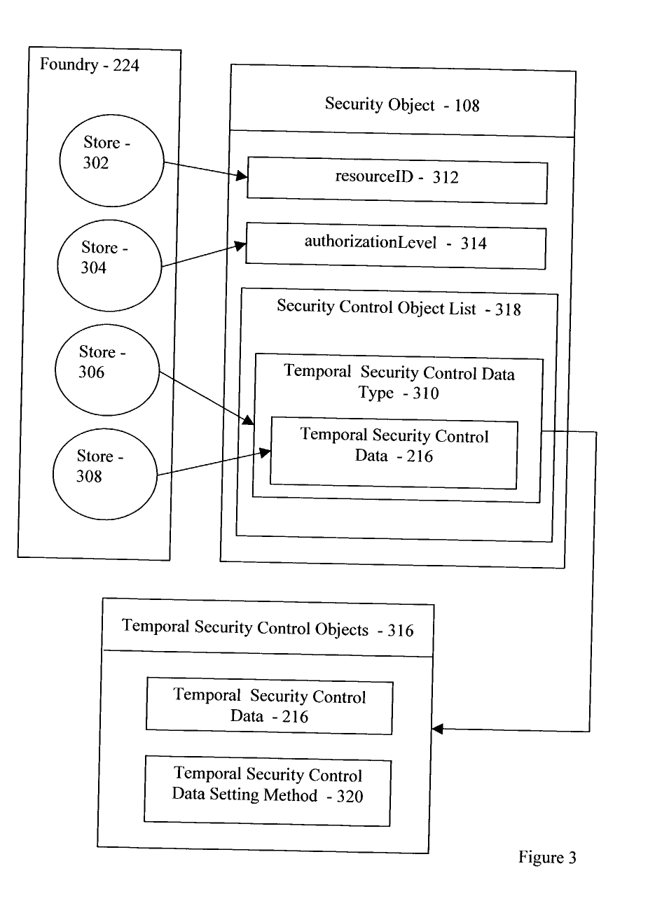

FIG. 3 sets forth a data flow diagram depicting an exemplary method of creating a security object. In other words, the method depicted in FIG. 3 drills down on what it means to create a security object in a foundry of the present invention. In the method of FIG. 3 creating a security object is shown to include storing (302) in the security object (108) a resource identification (312) for the resource. In other words, the foundry prompts the user to enter a filename, pathname, URL, URI, or any useful means as will occur to those of skill in the art for identifying a resource to be secured by the security object. In this example, the foundry then stores (302) the identification of the resource in a member field called ‘resourceID’ (312) in the security object itself.

In the method of FIG. 3 creating a security object optionally includes storing (304) in the security object (108) an authorization level (314) of access for the resource. hi other words, the foundry prompts the user to enter an authorization level, ‘read,’ ‘write,’ or ‘execute,’ for example, and then stores (304) the authorization level in a member field named ‘authorizationLevel’ (314) in the security object itself.

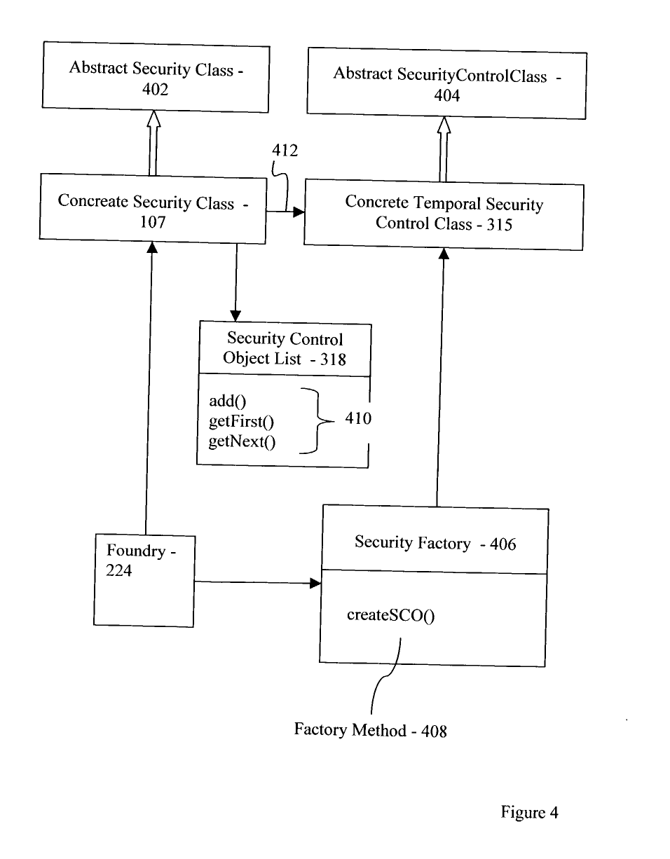

In the method of FIG. 3, creating a security object includes storing (306) in the security object (108) user-selected temporal security control data types (310). More particularly, in the method of FIG. 3, temporal security control data types (310) are stored as references to the temporal security control objects (316). Temporal security control data types (310) in fact are temporal security control classes (404 on FIG. 4) from which temporal security control objects are instantiated. Storing (306) user-selected temporal security control data types comprises storing references to temporal security control objects (316) in a security control object list (318) in the security object (108), including instantiating a temporal security control object (316) of a temporal security control class in dependence upon temporal security control data type.

That is, if the temporal security control data type is a security control class that implements a maximum number of invocations, then the foundry causes to be instantiated from a temporal security control class a temporal security control object valid only for a maximum number of invocations, storing in the security control object list (318) a reference to the temporal security control object valid for a maximum number of invocations. Similarly, if the temporal security control data type is a security control class valid only for a predetermined period of time, then the foundry causes to be instantiated from a temporal security control class a temporal security control object valid only for a period of time, storing in the security control object list (318) a reference to the temporal security control object valid only for a period of time. And so on.

The security control object list (318) itself is typically implemented as a container object from a standard library in an object oriented language such as, for example, Smalltalk, C++ or Java. That is, the security control object list (318) is typically a class object aggregated or associated by reference to the security object (108).

In the method of FIG. 3, creating a security object includes storing (308), in the security object, temporal security control data (216) for each user-selected temporal security control data type (310). Instantiating a temporal security control object (316) calls a constructor for the temporal security control object. Either a constructor or some other member method in a security control object, such as, for example, the temporal security control data setting method shown at reference (320) on FIG. 3, prompts for temporal security control data of the type associated with the temporal security control object. That is, if a temporal security control object is a temporal security control object implementing a maximum of invocations, its constructor or a data setting member method prompts for a maximum number of invocations to be stored (308) as temporal security control data (216). Similarly, if the temporal security control object is a security control object implementing a validity period, its constructor or a data setting member method prompts for a start time and an end time or validity period duration to be stored (308) as temporal security control data (216). And so on.

In architectures similar to those illustrated in FIGS. 1a and 1b in which a client device (102) is located remotely across a network (114) from a security server (106) upon which temporal security control data is to be stored (308), temporal security control data advantageously may be communicated across the network from the client device to the security server in encrypted form. One example of such encrypted communications is network messaging by use of ‘SSL,’ that is, communications connections through a ‘Secure Sockets Layer,’ a known security protocol for use in internet protocol (“IP”) networks, in which encryption of message packets is provided as a standard communications service. In addition to encrypted communications of temporal security control data, at least some elements of temporal security control data also are advantageously stored (308) in encrypted form.

Even more particularly, foundries according to the present invention may be implemented and operated in accordance with the following pseudocode.

Class Foundry {

private String selectionText =

“Please select a temporal security control data type:

1. Password
2. Fingerprint
3. Voice Recognition
4. Maximum Number of Invocations
5. Validity Period
6. Throttle
7. Threshold

Your selection (1-7): _”

void main() {

// create security object
SecurityClass SO = new SecurityClass();
//identify resource secured by the new security object
Resource resourceID =

getResourceID(“Please enter resource ID: _”);

// store resource ID in security object
SO.setResource(resourceID);
// prompt for authorization level
char authorizationLevel =

getAuthorizationLevel(“Please enter authorization level: _”);

// store authorization level in security object
SO.setAuthorizationLevel(authorizationLevel);
// get a first ‘SCD-Type,’ Temporal security control Data Type
SCD-Type = getUserSelection(selectionText);
while(SCD-Type != null) {

// based on SCD-Type, create Temporal security control Object
SCO = SCO-Factory.createSCO(SCD-Type);
// store temporal security control data in the temporal security
control object
SCO.setSecurityControlData();
// add new SCO to the list in the Security Object
SO.add(SCO);
// get another SCD-Type, as many as user wants
SCD-Type = getUserSelection(selectionText);

} // end while()

} // end main()

} // end Foundry

With reference to FIGS. 2 and 3, the pseudocode foundry creates (206) a security object (108) by instantiating a security class:

SecurityClass SO=new SecurityClass( ).

The pseudocode foundry then stores (302) a resource identification (312) through:

Resource resourceID=getResourceID(“Please enter resource ID: ______”);

SO.setResource(resourceID);

The call to SO.setResource( ) is a call to a member method in the security object described in more detail below. The pseudocode foundry stores (304) an authorization level (314) through:

char authorizationLevel=getAuthorizationLevel(“Please enter authorization level: ______”)

SO.setAuthorizationLevel(authorizationLevel);

The call to SO.setAuthoriztionLevel( ) is a call to a member method in the security object described in more detail below.

The pseudocode foundry stores (306) temporal security control data types (310) by repeated calls to SO.add(SCO). SO.add( ) is a member method in the security object that adds temporal security control objects to a list in the security object as described in more detail below.

The pseudocode foundry stores (308) temporal security control data (216) in the security object (108) by repeated calls to SCO.setSecurityControlData( ). SCO.setSecurityControlData( ) is a member method in a temporal security control object (316) that prompts for and stores a type of security data with which the temporal security control object is associated, fingerprints for fingerprint temporal security control objects, passwords for password temporal security control objects, and so on. A separate temporal security control object is created for each temporal security control data type selected or requested by the user in response to getUserSelection(selectionText). To illustrate that foundries can be used to aggregate with security objects non-temporal security control objects as well as temporal security control objects, selectionText is set to prompt for exemplary non-temporal security control data types for passwords, fingerprints, and voice recognition as well the temporal security control data types as shown.

Each time the user selects a new temporal security control data type, the foundry creates a new temporal security control object by calling a factory method in a temporal security control object factory. The temporal security control object factory is a class called SCO-Factory, and the factory method is SCO-Factory.createSCO( ). The calls to SCO.setSecurityControlData( ) are polymorphic calls, each of which typically accesses a different temporal security control object although exactly the same line of code is used for each such call. In this elegant solution, the foundry itself never knows or cares which temporal security control data types are implemented or what temporal security control data is stored in security objects it creates.

Readers of skill in the art will notice that the foundry could be made even leaner by allowing temporal security control object constructors to carry out the work of SCO.setSecurityControlData( ). In this example, however, for clarity of explanation of the operation of the foundry, a call to SCO.setSecurityControlData( ) is left at the foundry level so that the effects of foundry operations are more fully exposed by the foundry pseudocode itself.

The process of creating temporal security control objects can be carried out as illustrated in the following factory class illustrated in pseudocode:

//
// Temporal security control Object Factory Class
//
// Defines a parameterized factory method for creating temporal security control
objects
//
class SCO-Factory {

public static SecurityControlClass createSCO(SCD-Type) {

// establish null reference to new Temporal security control Object
SecurityControlClass SecurityControlObject = null;
switch(SCD-Type) {

case LOGONID:

SecurityControlObject = new LogonIDSecurityControlClass;
break;

case PASSWORD:

SecurityControlObject = new PasswordSecurityControlClass;
break;

| | |
|---|---|
| ... ... ... | // Can have many temporal security ‘control data types, |

// not merely these four

case FINGERPRINT:

SecurityControlObject = new FingerprintSecurityControlClass;
break;

case RETINA:

SecurityControlObject = new RetinaSecurityControlClass;
break;

} // end switch()
return SecurityControlObject;

} // end createSCO()

} // end class SCO-Factory

The factory class defines the createSCO( ) method, which is a so-called parameterized factory method. CreateSCO( ) accepts as a parameter the temporal security control data type ‘SCD-Type’ of the temporal security control data to be administered by a temporal security control object. CreateSCO( ) then operates a switch( ) statement in dependence upon SCD-Type to decide exactly which temporal security control class to instantiate depending on which type of temporal security control data is needed—logon IDs, passwords, fingerprints, voice identifications, and so on. Although only four temporal security control data types are illustrated in the factory class (logon IDs, passwords, fingerprints, and retinal scans), in fact the factory can create and return to the calling foundry a temporal security control object for any type of temporal security control data supported by the security system in which it is installed, that is, any type of temporal security control object for which a temporal security control data type or class (404) is defined.

Concrete temporal security control classes can be defined as derived classes inheriting from a security control class according to the following exemplary abstract security control class illustrated in pseudocode:

//
// abstract SecurityControlClass
//
Abstract Class SecurityControlClass {

private String SecurityControlData;
public void setSecurityControlData( ) {

SecurityControlData =

prompt( “Please enter temporal security control data:
_{———});

}
public boolean validate( ) {

SecurityAccessData =

prompt(“Enter Security request data: _{———}”);

if(SecurityControlData == SecurityAccessData) return true;
else return false;

}

}

The abstract security control class depicts an object oriented ‘interface.’ In Java, such structures are literally known as ‘interfaces’ to be ‘extended’ by concrete classes. In C++, such structures are known as abstract base classes from which concrete subclasses inherit. Either way, the abstract security control class establishes a set of public member methods to be used by all temporal security control objects. The interface of the abstract security control class can be used by non-temporal security control objects as well. The pseudocode security control class provides string storage of temporal security control data in the field named ‘securityControlData,’ which may work just fine for certain non-temporal security control data types such as logon IDs and passwords, but is less likely to be needed as such for use with temporal security control data types.

Similarly, setSecurityContolData( ) and validates will be implemented differently for different types of temporal security control data. Such different implementations are often effected by overrides in subclasses, and that will often be the case for temporal security control objects. In fact, the member fields and member methods of the pseudocode security control class form an interface that is fully expected to be overridden in concrete subclasses from which temporal security control objects are instantiated, although all concrete temporal subclasses are expected to implement in some fashion the public members of an interface from, for example, an abstract base class such as, for example, SecurityControlClass.

Temporal Security Controls

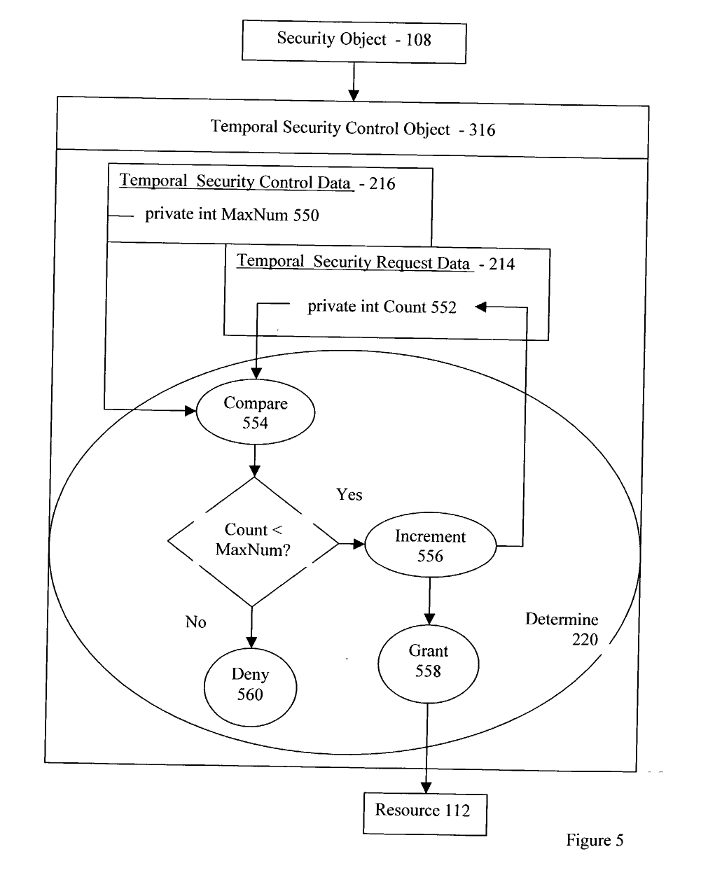

Here, beginning with a concrete temporal security control class for a maximum number of invocations, are several examples of concrete temporal security control classes from which practical temporal security control objects can be instantiated by a factory method such as SecurityControlClass.createSCO( ). The following discussion of temporal security control classes centers in the drawings on FIGS. 5, 6, 7, and 8.

Security Control Objects for A Maximum Number of Invocations

FIG. 5 is a combination class and control flow diagram depicting a method of temporal control of access to a resource in which temporal security control data (216) comprises a maximum (550) allowable number of invocations of the security object, temporal security request data (214) comprises a count (552) of invocations of the security object, and determining (220) access to the resource (112) in dependence upon the temporal security control data and the temporal security request data further comprises comparing (554) the maximum allowable number of invocations (550) and the count (552) of invocations. In the method according to FIG. 5, determining (220) access to the resource includes incrementing (556) the count of invocations in dependence upon whether the maximum (550) allowable number of invocations is greater than the count (552) of invocations and granting (558) access to the resource in dependence upon whether the maximum (550) allowable number of invocations is greater than the count (552) of invocations.

More particularly, the method of FIG. 5 can be carried out by use of a security control class defining a security control data type that will support a security object valid only for a predefined number of invocations defined according to the following pseudocode example:

//
// concrete temporal security control class for a
// predefined maximum number of invocations
//
Class MaximumInvocationClass : SecurityControlClass {

private int MaxNum;
private int Count;
public void setSecurityControlData() {

MaxNum = prompt( “Enter maximum number of invocations:
_);

}
public boolean validate() {

if(Count < MaxNum) {

Count += 1;
return true;

}
else return false;

}

} // end MaximumInvocationClass

MaximumInvocationClass implements Count in persistent storage. MaximumInvocationClass.setSecurityControlData( ) is a security control data setting member method described above in connection with reference (320) on FIG. 3. So long as Count is less than MaxNum, setSecurityControlData( ) increments Count every time MaximumInvocationClass (or an object instantiating it) is invoked. After Count is incremented to be equal to MaxNum, Count is never again incremented, but is left at a value equal to MaxNum. After Count is incremented to be equal to MaxNum, validates always returns ‘false,’ indicating to a calling security object that the security object is to deny access to the resource controlled by the security object. Although a security control object of MaximumInvocationClass continues to exist and accept invocations after Count is incremented equal to MaxNum, it never again allows access to the resource its security object secures.

Security Control Objects for a Period of Time

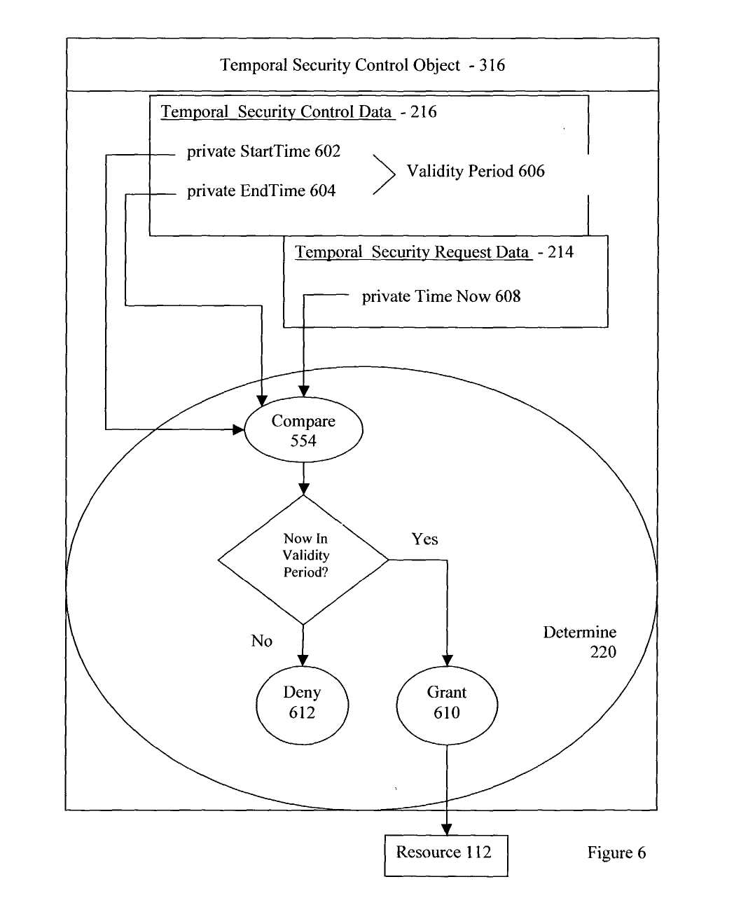

FIG. 6 is a combination class and control flow diagram depicting a method of temporal control of access to a resource in which temporal security control data comprises a starting validity time (602) and an ending validity time (604), the starting validity time and the ending validity time defining a validity period (606) for the security object. In the method according to FIG. 6, the temporal security request data comprises a time (608) when the security object is invoked. In the method according to FIG. 6, determining (220) access to the resource in dependence upon the temporal security control data (216) and the temporal security request data (214) further comprises determining whether the time (608) when the security object is invoked is within the validity period (606). As a practical matter, determining whether the time (608) when the security object is invoked is within the validity period (606) often includes comparing (554) the time (608) when the security object is invoked with both the starting validity time (602) and the ending validity time (604). In the method according to FIG. 6, determining (220) access to the resource includes granting (610) access to the resource in dependence upon whether the time when the security object is invoked is within the validity period.

More particularly, the method of FIG. 6 can be carried out by a security control class defining a security control data type that will support a security object valid only for a predefined period of time defined according to the following pseudocode example:

//
// concrete temporal security control class for a
// predefined period of time
//
Class TimePeriodClass: SecurityControlClass {

private Time StartTime;
private Time EndTime;
private Time Now;
public void setSecurityControlData() {

StartTime = prompt( “Enter Start Time: _);
EndTime = prompt( “Enter End Time: _);

}
public boolean validate() {

Now = getSystemClockTime();
// still in validity period
If(Now > StartTime && Now < EndTime)

return true;

// outside validity period
else return false;

}

} // end TimePeriodClass

TimePeriodClass implements StartTime and EndTime in persistent storage. TimePeriodClass.setSecurityControlData( ) is a security control data setting member method described above in connection with reference (320) on FIG. 3. The period between StartTime and EndTime is the validity period for the TimePeriodClass and security control objects instantiating it. When ‘Now,’ the time when an associated security object in invoked, is within the validity period, validates return ‘true,’ granting access. If Now is prior to the validity period, that is, Now is less than StartTime, validates excludes access until Now is within the validity period. When Now is after the validity period, that is, Now is greater then EndTime, validates never again grants access, even if its security control object continues to exist.

Security Control Objects Implementing Throttles

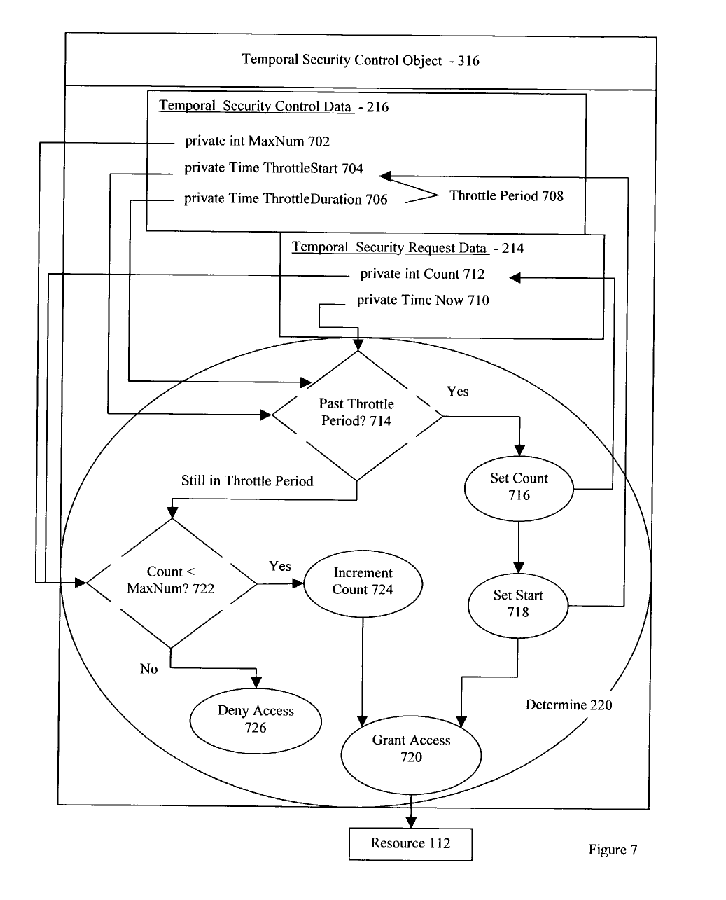

FIG. 7 is a combination class and control flow diagram depicting a method of temporal control of access to a resource in which temporal security control data (216) comprises a maximum (702) allowable number of invocations of the security object during a throttle period, a throttle start time (704) and throttle duration (706), the throttle start time and the throttle duration defining the throttle period (708). In the method of FIG. 7, temporal security request data (214) comprises a time (710) when the security object is invoked and a count (712) of invocations of the security object during the throttle period. In the method of FIG. 7, determining (220) access to the resource in dependence upon the temporal security control data (216) and the temporal security request data (214) comprises determining (714) whether the time when the security object is invoked is within the throttle period and, optionally, determining whether the count (712) of invocations is less than the maximum (702) allowable number of invocations. Determining whether a count (712) is less than a maximum (702) is optional in the sense that the determination may not be carried out if the time (710) when the security object is invoked is outside the throttle period (708). In the method of FIG. 7, determining (220) access to the resource (112) includes determining (220) access to the resource in dependence upon whether the time (710) when the security object is invoked is within the throttle period (708) and optionally upon whether the count (712) of invocations is less than the maximum (702) allowable number of invocations.

In the method of temporal control of access to a resource according to FIG. 7, determining (714) whether the time when the security object is invoked is within the throttle period can result in a determination that the time when the security object is invoked is within the throttle period. In addition, determining (722) whether the maximum allowable number of invocations is greater than the count (712) of invocations can result in a determination that the count (712) of invocations is less than the maximum (702) allowable number of invocations during the throttle period. In such an instance, the method typically includes incrementing (724) the count (712) of invocations and granting (720) access to the resource (112).

In the method of temporal control of access to a resource according to FIG. 7, determining (714) whether the time when the security object is invoked is within the throttle period can result in a determination that the time when the security object is invoked is past the throttle period, in which case, the method typically includes setting (716) the count (712) of invocations during the throttle period to one, setting (718) the throttle start time (704) to the time (710) when the security object is invoked, and granting (720) access to the resource (112).

In the method of temporal control of access to a resource according to FIG. 7, determining (714) whether the time when the security object is invoked is within the throttle period can result in a determination that the time when the security object is invoked is within the throttle period, in which case, the method typically includes determining (722) whether the maximum allowable number of invocations is greater than the count (712) of invocations. Determining (722) whether the maximum allowable number of invocations is greater than the count (712) of invocations, can result in a determination that the count (712) of invocations is at least equal to the maximum (702) allowable number of invocations during the throttle period, and, if so, denying (726) access to the resource (112).

More particularly, the method of FIG. 7 can be carried out by a security control class defining a security control data type that will support a throttled security object, that is, a security object valid only for a predetermined number of invocations during a predefined period of time, defined according to the following pseudocode example:

//
// concrete temporal security control class for a
// ‘throttled security object’ ... valid for a
// predefined number of invocations during a
// predefined period of time
//
Class ThrottleClass: SecurityControlClass {

private Time ThrottleStart;
private Time ThrottleDuration;
private int Count;
private Time Now;
private int MaxNum; // max invocations
public void setSecurityControlData() {

ThrottleStart = getSystemClockTime();
ThrottleDuration = prompt( “Enter Throttle Duration: _);

}
public boolean validate() {

Now = getSystemClockTime();
// if past throttle period
If(Now - ThrottleStart > ThrottleDuration) {

Count = 1; // reset Count
ThrottleStart = Now; // reset start time
return true; // validate for access

}
else { // still in throttle period

// count still not to max
if(Count < MaxNum) {

Count += 1; //increment count
return true; // validate

}
// count up to max, kill access
else return false;

} // end if

} // end validate()

} // end ThrottleClass

ThrottleClass implements ThrottleStart, ThrottleDuration, and Count in persistent storage. ThrottleClass.setSecurityControlData( ) is a security control data setting member method described above in connection with reference (320) on FIG. 3. Upon a first invocation after a throttle period, when it no longer matters whether Count exceeded MaxNum during a previous throttle period, validates resets Count to 1 (thereby counting the present invocation), resets ThrottleStart to the present time Now, and returns true to grant access. On subsequent invocation during the throttle period, validate( ) grants access if Count is less than MaxNum.

In operation of security control objects instantiated from ThrottleClass, resetting ThrottleStart and Count after each throttle period means that such security objects never really die of their own accord. Instead, such security objects are in effect temporarily disabled in terms of access to resources during any period of time remaining in a throttle period after Count is incremented equal to MaxNum.

Security Control Objects Implementing Thresholds

It is advantageous to have security objects capable of securing access to resources that are accessed at least a minimum number of times during a predefined time period. For example, a user may advantageously exclude access to a microcomputer unless it is accessed at least weekly. Such controls are useful, for example, for resources assumed to be stolen if they are not used with a certain minimum frequency. Such controls are also useful for resources assumed to be no longer needed by a particular user, for example, unless they are accessed with some minimum frequency.

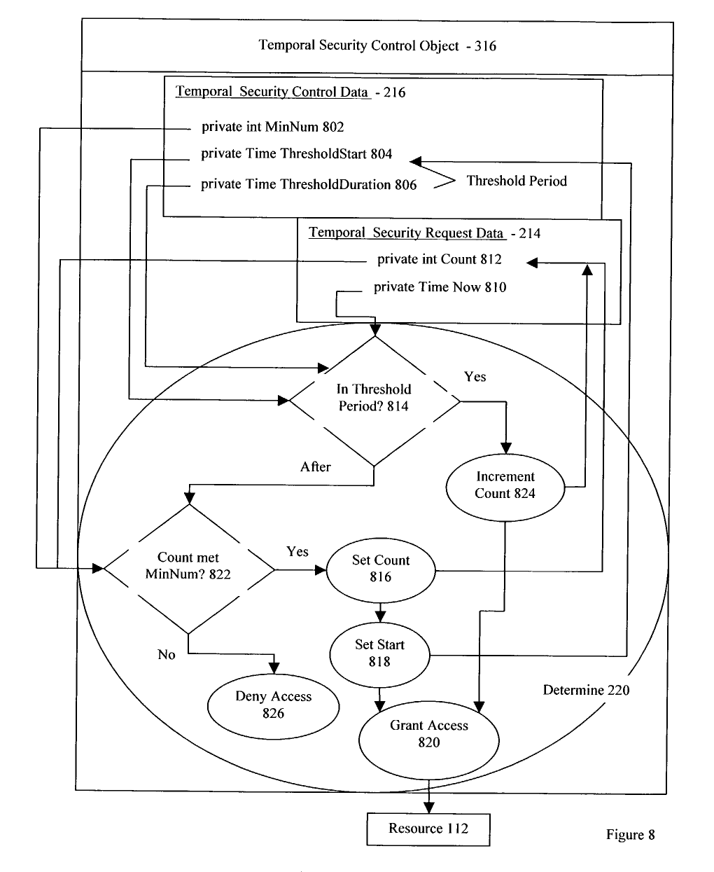

FIG. 8 is a combination class and control flow diagram depicting a method of temporal control of access to a resource in which temporal security control data (216) comprises a minimum (802) allowable number of invocations of the security object during a threshold period, a threshold start time (804) and threshold duration (806), the threshold start time (804) and the threshold duration (806) defining the threshold period (808). In the method according to FIG. 8, temporal security request data (214) comprises a time (810) when the security object is invoked and a count (812) of invocations of the security object during the threshold period. In the method according to FIG. 8, determining (220) access to the resource in dependence upon the temporal security control data (216) and the temporal security request data (214) includes determining (814) whether the time (810) when the security object is invoked is within the threshold period (808) and, optionally, determining whether the count (812) of invocations is at least equal to the minimum (802) allowable number of invocations during the threshold period. In the method according to FIG. 8, determining (220) access includes determining access to the resource in dependence upon whether the time (810) when the security object is invoked is within the threshold period (808) and optionally upon whether the count (812) of invocations is at least equal to the minimum (802) allowable number of invocations during the threshold period.

More particularly, in the method of temporal control of access to a resource according to FIG. 8, determining (814) whether the time (810) when the security object is invoked is within the threshold period (808) can result in a determination that the time (810) when the security object is invoked is within the threshold period (808). In such a case, the method typically includes incrementing (824) the count (812) of invocations and granting (820) access to the resource (112).

In the method of temporal control of access to a resource according to FIG. 8, determining (814) whether the time (810) when the security object is invoked is within the threshold period (808) can result in a determination that the time (810) when the security object is invoked is after the threshold period (808). In such a case, the method typically includes determining (822) whether the count (812) of invocations is at least equal to the minimum (802) allowable number of invocations during the threshold period, which in turn can result in a determination that the count (812) of invocations is at least equal to the minimum (802) allowable number of invocations during the threshold period. If so, the method typically includes setting (816) the count of invocations during the threshold period to one, setting (818) the threshold period start time to the time when the security object is invoked, and granting (820) access to the resource (112).

In the method of temporal control of access to a resource according to FIG. 8, determining (814) whether the time (810) when the security object is invoked is within the threshold period (808) can result in a determination that the time (810) when the security object is invoked is after the threshold period (808). In such a case the method typically includes determining (822) whether the count (812) of invocations is at least equal to the minimum (802) allowable number of invocations during the threshold period, which can result in a determination that the count (812) of invocations is less than the minimum (802) allowable number of invocations during the threshold period. If so, the method typically includes denying (826) access to the resource (112).

More particularly, the method of FIG. 8 can be carried out by use of a security control class defining a security control data type that will support a threshold security object, that is, a security object valid only so long as the number of invocations of the security object meets a predefined minimum for a predefined period of time, can be defined according to the following pseudocode example:

//
// concrete temporal security control class for a
// ‘threshold security object’ ... valid so long as
// invocations are at least a predefined minimum
// during a predefined period of time
//
Class ThresholdClass: SecurityControlClass {

private Time ThresholdStart;
private Time ThresholdDuration;
private int Count;
private Time Now;
private int MinNum; // minimum required invocations
public void setSecurityControlData() {

ThresholdStart = getSystemClockTime();
ThresholdDuration = prompt( “Enter Threshold Duration:
_);

}
public boolean validate() {

Now = getSystemClockTime();
// still inside threshold period
If(Now - ThresholdStart < ThresholdDuration) {

Count += 1; //increment Count
return true; // validate for access

}
else { // past threshold period

// count met the minimum
if(Count => MinNum) {

Count = 1; // reset count
ThresholdStart = Now; // reset start time
return true; // validate

}
// count failed minimum, kill access
else return false;

} // end if

} // end validate()

} // end ThresholdClass

ThresholdClass implements ThresholdStart, ThresholdDuration, and Count in persistent storage. ThresholdClass.setSecurityControlData( ) is a security control data setting member method described above in connection with reference (320) on FIG. 3. A threshold period is described by the expression “Now—ThresholdStart<ThresholdDuration” in the member method validate( ).

Invocations during a threshold period are of no concern except for tracking the number of invocations by incrementing Count; access is always granted during a threshold period so long as Count never fails to meet the minimum requirement. The test whether Count meets the minimum occurs after a threshold period. The test is “Count=>MinNum.”

If Count meets the minimum, validate( ) resets Count, resets ThresholdStart, and continues to grant access. If Count fails the minimum, Count and ThresholdStart are not reset, meaning that forevermore Now is outside the threshold period and Count fails the minimum, effecting killing access to a resource secured by a security object associated with a security control object instantiated from ThresholdClass. So long as Count always reaches MinNum during each threshold period, such security control objects never die. If Count ever fails to reach MinNum during a threshold period, such security control objects are effectively terminated for access to a resource, even if they continue, strictly speaking, to exist as instantiations in computer memory.

Non-Temporal Security Control Objects

Here, beginning with a concrete non-temporal security control class for logon IDs, are several examples of concrete non-temporal security control classes from which practical non-temporal security control objects are instantiated by the factory method SecurityControlClass.createSCO( ). Although the present invention is directed primarily toward temporal security control, the use of non-temporal security control objects, although optional, is nevertheless well within the scope of the present invention, and the following few examples help to illustrate the overall structure and function of security control objects generally.

//
// concrete security control class for logon IDs
//
Class LogonIDSecurityControlClass : SecurityControlClass {

private String SecurityControlData;
public void setSecurityControlData() {

SecurityControlData =

prompt( “Please enter temporal security control data:
_);

}
public boolean validate() {

SecurityAccessData =

prompt(“Enter Security request data: _”);

if(SecurityControlData == SecurityAecessData) return true;
else return false;

}

}

The LogonIDSecurityControlClass appears almost identical to its parent SecurityControlClass, but it is useful to note that LogonIDSecurityControlClass, unlike its abstract parent, defines a class that can actually be instantiated as a security control object for determining access to resources on the basis of entry of a valid logon ID. The following pseudocode illustration of a security control class for fingerprints illustrates how security control classes differ across security control data types.

//
// concrete non-temporal security control class for fingerprints
//
Class FingerprintSecurityControlClass : SecurityControlClass {

private File SecurityControlData;
public void setSecurityControlData( ) {

SecurityControlData =

prompt( “Please enter temporal security control data:
_{———});

}
public boolean validate( ) {

FILE SecurityAccessData =

prompt(“Enter Security request data: _{———}”);

if((bitwiseCompare(SecurityControlData, SecurityAccessData)) !=true)

return true;

else return false;

}

}

In FingerprintSecurityControlClass, SecurityControlData is in a file rather than a string. Similarly, the prompt( ) function in the validate( ) method expects the user to provide a fingerprint file in response to the prompt for security control data. In addition, the bitwiseCompare( ) method, although not shown, is implemented to open both files, compare them bit by bit, and ultimately deny access to a resource if the comparison fails.

Security objects themselves can be implemented, for example, according to the following pseudocode security class.

//
// SecurityClass ... the class from which security objects are instantiated
//
Class SecurityClass
{

private Resource aResourceID;
public void setResourceID(resourceID) {

aResourceID = resourceID

}
char anAuthorizationLevel;
public void setAuthorizationLevel(authorizationLevel) {

anAuthorizationLevel = authorizationLevel

}
// list of temporal security control objects (references, actually)
private List aList = new List();
// method for adding Temporal security control Objects to the list
public void add(SCO) {

aList.add(SCO);

}
// validate requests for access against all SCOs in the list
public boolean main()
{

SCO = aList.getFirst();
while(SCO != null)
{

if((SCO.validate()) != true) {

denyAccess();
return false;

}
SCO = aList.getNext();

}
// all SCOs in the list are now validated
grantAccess(anAuthorizationLevel);
return true;

} // end validate()

} // end SecurityClass

The security class provides a storage location for a resource identification (312) named ‘resource ID,’ as well a member method named setResourceID( ) for storing (302) the resource identification. Similarly, the security class provides a field for authorization level and a method for storing (304) authorization level. The exemplary pseudocode security class provides storage in the form of a list for storing security control objects, both temporal and non-temporal. In C++, it would be possible to store security control objects as such, but in typical embodiments, the list is used to store security control objects as references.

The security class includes a method, addSCO( ) for adding a security control object to the list. The methods aList.add( ), aList.getFirst( ), and aList.getNext( ) are member methods in a list object that effectively operate a list object as an iterator. An ‘iterator’ is a conventional object oriented design pattern that supports sequential calls to elements of an aggregate object without exposing underlying representation. In this example, main( ) assumes that aList.getNext( ) returns null upon reaching the end of the list. It is common also, for example, for list classes to support a separate member method called, for example, ‘isDone( ),’ to indicate the end of a list. Any indication of the end of a list as will occur to those of skill in the art is well within the scope of the present invention.

In addition, the exemplary pseudocode security class includes a member method, main( ), that validates security request data in turn for each security control object in the list. In this particular example, the validation method is called ‘main( )’ to support implementing security objects in Java, so that the validation method can be called by a call to the object name itself. On the other hand, when SecurityClass is implemented as a Java servlet, there is no requirement for a member method named ‘main( ),’ because, although servlets also are invoked by use of the class name itself, the interior interface requirements for servlets are different. When SecurityClass is implemented as a Java servlet, therefore, the name of the member method ‘main( )’ is changed to implement a member method signature from the standard Java servlet interface, such as, for example:

public void service(ServletRequest req, ServletResponse res).

The validation method main( ) operates by obtaining from the list each security control object in turn and calling in each security control object the interface member method ‘validates.’ As described in detail above, the validates method in each security control object prompts for security request data, compares security request data to security control data, and return true or false according to whether the comparison succeeds or fails. SecurityClass.main( ) operates by denying access and returning false if validation fails for any security control object in the list. SecurityClass.main( ) grants access and return true if validation succeeds for all security control objects in the list.

If SecurityClass.main( ) grants access, the access granted has the authorization level set by the member method setAuthorizationLevel( ). More particularly, in the method of FIG. 2, determining (220) access (222) includes authorizing a level of access in dependence upon the authorization level of access for the resource (314 on FIG. 3). In the example of security objects implemented to accept calls from hyperlinks in web pages displayed in browsers on client devices located remotely across a network, the security objects themselves often are implemented as servlets or CGI programs that administer HTTP GET and PUT request messages. In such exemplary embodiments, a security object granting access to a resource having only ‘read’ authorization level would honor a GET request by transmitting to the client browser a copy of the resource in HTML. The same exemplary security object, however, would not honor a PUT request for writing data to the resource.

FIG. 4 sets forth a class relations diagram summarizing exemplary relations among classes and objects useful in various embodiments of the present invention. As shown in the example of FIG. 4, useful in many embodiments, concretes security classes (107), from which security objects are instantiated, are subclasses that inherit from abstract security classes (402). Similarly, concrete temporal security control classes (315), from which temporal security control objects are instantiated, are subclasses that inherit from abstract security control classes (404). As described above, abstract security control classes (404) can declare interfaces for both temporal and non-temporal concrete security control subclasses.

In addition, it is useful to remember that ‘abstract,’ as the term is used here to describe classes, is used in support of interface definition, in a fashion similar to its use in the terminology of C++. In Java, structures that here are called abstract classes would be called ‘interfaces,’ as such. No doubt such structures have other names in other environments, but here they are called ‘abstract classes’ and used to illustrate declarations of object oriented interfaces.

Foundries (224) are shown in FIG. 4 as classes having references to factory classes (406) and concrete security classes (107). Foundries (224), as described in detail above, cooperate with factories (406) and security objects instantiated from concrete security classes (315) by passing to security objects references to temporal security control objects for inclusion in security control object lists (318). The arrow (412) between security classes (107) and security control classes (315) indicates that a security class ‘has a’ security control class, because the reference needed to implement the object oriented ‘has a’ relationship is provided to the security class by a foundry (224) for storage in a security control object list (318).

Security control object lists (318) are often implemented as container objects from a standard library in, for example, C++ or Java. That is, a security control object list (318) is typically a class object aggregated by reference to a security object instantiated from a security class (107). With member methods (410) such as add( ), getFirst( ), and getNext( ), a security control object list (318) often can function as a so called ‘iterator,’ greatly easing manipulation of temporal security control objects on behalf of a security object. Iterator operations are illustrated in the pseudocode above for SecurityClass.

Again referring to FIG. 2, the illustrated method includes deploying (226) a security object. Security objects can be created (206) on a client device and deployed (226) to a client device (102), including the same client device on which the security object is created, or to a server (106). Security objects can be created (206) on a server and deployed (226) to a server (106), including the same server on which the security object is created, or to a client device (102). Deployment can be local, that is, within the same client device or server, or within a trusted LAN.

Deployment can be remote, that is, across public networks, such as, for example, the Internet or the World Wide Web. One advantageous mode of remote deployment, for example, is a download of a security object implemented as a Java applet to a Java-enabled web browser. An applet is a Java program designed to be run from another program, such as a browser, rather than directly from an operating system. Because applets typically are small in file size, cross-platform compatible, and highly secure (can't be used to access users' hard drives), they are useful for small Internet applications accessible from a browser, including, for example, security objects according to the present invention.

More particularly, in some embodiments according to the method of FIG. 2, a resource (112) resides on a resource server (110), and the method includes deploying (226) the security object (108) on a security server (106) and receiving (208) the request for access to the resource in a security server (106) from a client device (102) across a network (202). Network (202), as mentioned above, can be any network, public or private, local area or wide area, wireless or wired. In embodiments according to this aspect of the invention, receiving (208) a request for access (210) is typically carried out through some form of remote procedure call, such as, for example, a hyperlink to a Java servlet, a hyperlink to a CGI function, a call to a member method in a CORBA object, a remote object call through a Java RMI interface, or a remote object call through a DCOM interface.

In a further aspect of the method of FIG. 2, a resource (112) resides on a client device (102), and the client device has an application program (120 on FIG. 1c) that accesses the resource. In this kind of embodiment, the method includes deploying (226) the security object (108) on the client device (102), effecting an architecture like the one shown in FIG. 1c. In this configuration, receiving (208) a request (210) for access to the resource (112) includes receiving (208) the request for access to the resource in the security object itself as a call to the security method (218). In some embodiments of this kind, in fact, a security object (108) can be compiled right into the client application (120), so that receiving a request for access is implemented as a conventional local function call, with no particular need for remote procedure calling methodologies such as those listed above—hyperlinks, CORBA, Java RMI, and so on.

In some embodiments of the present invention receiving (208) a request (210) for access to a resource (112) comprises a call to a security method (218) in a security object (108). Such direct calls can be implemented through Java, for example, by naming the security method (218) ‘main( )’ and issuing a call of the form ‘java SecurityObjectName.’ Alternatively, a call may be issued from a hyperlink in a browser to a security method in a security object implemented as a Java servlet by including in an HTTP request message a URI of the form:

http://ServerName/servlet/MySecurityObject

where MySecurityObject is the name of a security object implemented as a servlet and containing a security method named according to the conventions of the standard Java servlet interface, that is, for example, named ‘service( ).’

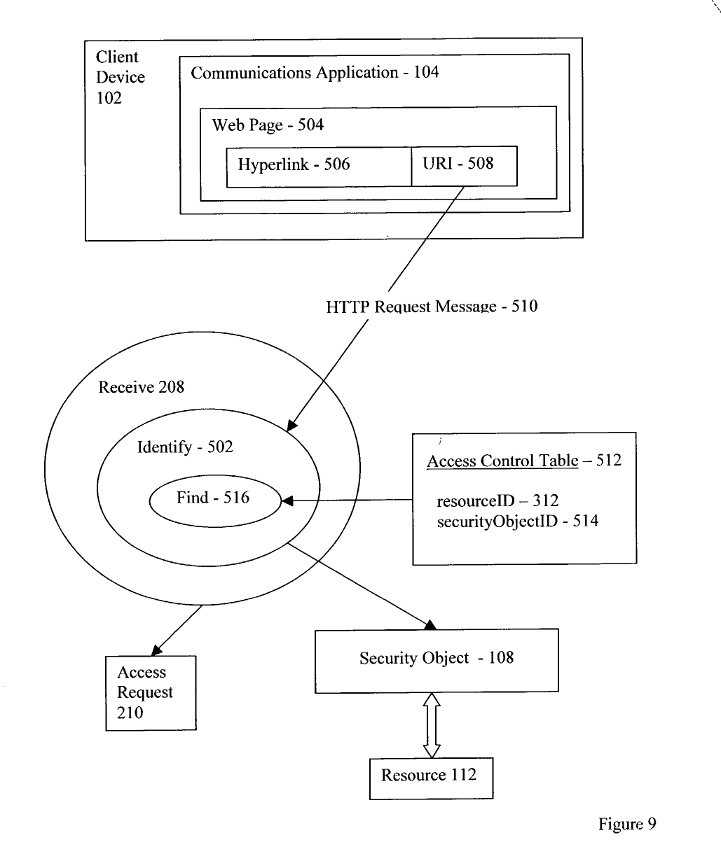

FIG. 9 sets forth a data flow diagram illustrating more detailed embodiments of receiving (208) a request (210) for access to a resource. Although this disclosure is primarily concerned with security objects implementing temporal security controls, the following discussion applies to non-temporal as well as temporal security controls. In one method according to FIG. 9, receiving (208) a request (210) for access to a resource (112) includes identifying (502) a security object (108), that is, identifying a security object that controls access to the resource. Consider the example mentioned earlier of a security object (108) implemented as a Java servlet. In such an exemplary embodiment, identifying (502) the security object (108) comprises identifying the security object in dependence upon a URI (508). Typically, the URI (508) originates from a hyperlink (506) in a web page (504) in a communications application (104) in a client device (102). The communications application can be, for example, a browser in a client device that is a personal computer or a microbrowser in a client device that is a web-enabled cell phone. Such embodiments typically communicate the identification of the security object in the form of an HTTP request message containing the URI. The URI can have this form:

http://ServerName/servlet/MySecurityObject

from which a servlet-enabled server can invoke the security object as a servlet named MySecurityObject. The server does not invoke the security object in the sense of calling it as such. The server ‘invokes’ the security object in that the server calls a member method within the security object according to the conventions of the standard Java servlet interface. In this example, the identity of the security object was known to the calling application.

It is possible, however, that the calling application may know the identity of a resource without knowing the identity of the security object that controls access to the resource. In such an exemplary embodiment, a request for access to a secured resource may arrive in an HTTP request directed at a resource that is a document identified as:

http://ServerName/SomeoneElse'sFiles/Document 123.

For use in such embodiments, in one method according to FIG. 9, identifying (502) the security object (108) includes identifying the security object in dependence upon a URI (508) that identifies the resource (112), including finding (516), in dependence upon the URI (508) identifying the resource (112), an identification (514) of the security object in an access control table (512).

Although in this example, where the access request came with a URI the identification (312) of the resource is, for example, a URI or a filename or pathname extracted from a URI. In embodiments of the invention generally, there is no requirement that the communications application be a browser or use HTTP for its communications. The resource identification (312) can be any digital identification, including for example, a filename or pathname communicated in a plaintext string or in cyphertext.

The identification (514) of the security object can be the security object name, for example, or, in the example where the security object is implemented as a Java servlet, the identification (514) of the security object can be a URI in the now familiar form:

http://ServerName/servlet/MySecurityObject.

In this kind of embodiment, a security server is programmed upon receiving a request for access, to check an access control table (512). In fact, this small change in the overall programming of the security server, may be in many embodiments the only thing that makes the security server a ‘security server’ within the meaning of the present invention. The security server needs no other security-related service upon it. Security authentication and authorization are handled by the security object. All the security server needs to do is look up the identity of the security object and invoke it. ‘Invoke’ in this sense means to call the security method in the security object by, for example, a call to ‘java SecurityObjectName’ for a security object implemented as a standard Java class, a call to ‘http://ServerName/servlet/MySecurityObject’ for a security object implemented as a Java servlet, or a call to ‘securityObjectName’ for a security object implemented as a C++ program. If the security server can find no security object for the resource identified in a request for access, then the security server continues its normal operations. If the security server is programmed to grant access only upon finding a corresponding security object, then the security server denies access when no such object is found in the access control table. If the security server has other security services available upon it, then it is often programmed to apply them in its usual fashion.

Alternatively, if the security server has no other security services available upon it, it may be programmed to comply with HTTP request messages on their own terms according to whether they are GET messages, PUT messages, and so on. In other words, the security server can implement the standard operations of a web server. This implementation is a little riskier than the other two examples mentioned just above but it has the advantage of being very easy to implement, requiring as it does only one small change to the source code of a conventional web server just to do one lookup in an access control table and, if the lookup succeeds, invoke a security object identified in the lookup.

By this point in this disclosure, several advantages of using various embodiments of the present invention are clear. One advantage is pure flexibility, especially at the user level and the application level. Embodiments of the present invention can make foundry applications available to ordinary users, rather then just to system administrators. Any user can choose to associate with any resource any kind of security data supported in a security system. Users can decide for themselves whether they want temporal controls without more or something much more elaborate: a throttled security object requiring a fingerprint or a retinal scan, for example. As a result, users can be given great freedom in defining security content and security level to secure users' resources, much greater freedom than would be available to a user in prior art systems.

Another advantage of security objects according to the present invention is that security servers, communications servers, resource servers such as document or application servers, that is, none of the servers in networks, need to have any particular concern with security beyond associating a security object with a resource. Moreover, as mentioned above, it is possible within the present invention to establish a regime in which all resources in a particular location are accessed only indirectly through security objects, in which case, a server providing access to such resources need have upon it no other security service whatsoever, at least as regards authentication and authority level. In particular, servers that administer access to resources need not be concerned with the type of security data provided by users or required to qualify for access to a resource.

Another advantage of the present invention relates to encryption. As described above, certain elements of temporal security control data are advantageously stored in encrypted form. Persons seeking unauthorized access to resources may seek to decrypt such temporal security control data. Such unauthorized access is made much more difficult by a need, easily established by any properly authorized user, to decrypt not only a single temporal security control data element such as a password, but also to decrypt multiple temporal security control data elements including fingerprints, retinal scans, voiceprints, and so on.

Another advantage of the present invention is the ease with which a user can arrange multiple access authorization for multiple users. A user authorized to do so, under the present invention, can simply create multiple security objects for a single resource and distribute, for example, a URI identifying each such separate security object to separate users. By such usage, a user can quickly grant with respect to a particular document, for example, ‘read’ access to Jane Smith, ‘read’ access to Joe Blow, ‘write’ access to Mike Walker, and reserve ‘execute’ access to the original user, the owner of the document. The temporal security control data can be set differently in each of the separate security objects all of which point to the same document, therefore preventing Jane and Joe from using Mike's security object to gain access, even if they can gain access to Mike's security object.

Another advantage is reduction of security responsibility on the part of server system administrators. This advantage obtains because security objects of the present invention tend to upcast temporal security control from communications protocols layers to application layers. “Layers” in this context refers to the standard data communications protocol stack in which the IP protocol resides in layer 3, the so called ‘network layer,’ and the Transmission Control Protocol, or “tcp,” resides in layer 4, the so called transport layer. In this context, SSL is considered a layer 4 security protocol, and the well known protocol for virtual private networking known as “IPSec” is considered a layer 3 protocol. In this disclosure, any functionality above layer 4 is described as residing in an ‘application layer.’ Therefore security objects according to the present invention are considered to be application layer software. As such, security objects and their operations in securing access to resources are completely transparent to systems administrators working on layer 4 or layer 3 security systems. In fact, it is possible to structure web servers as security servers, as mentioned above, so that such security servers have little or no concern regarding whether layer 4 or layer 3 security systems even exist at all. This is potentially a dramatic shift in security responsibilities for system administrators, including, for example, system administrators in Internet Service Providers or ‘ISPs.’

It will be understood from the foregoing description that various modifications and changes may be made, and in fact will be made, in the exemplary embodiments of the present invention without departing from its true spirit. The descriptions in this specification are for purposes of illustration only and are not to be construed in a limiting sense. The scope of the present invention is limited only by the language of the following claims.

What is claimed is:

1. A method of temporal control of access to a resource, the method comprising:
creating a security object in dependence upon user-selected temporal security control data types, the security object comprising temporal security control data and at least one security method;
receiving a request for access to the resource;
receiving temporal security request data; and
determining access to the resource in dependence upon the temporal security control data and the temporal security request data.

2. The method of temporal control of access to a resource according to claim 1 wherein creating a security object further comprises:
storing in the security object a resource identification for the resource;
storing in the security object user-selected temporal security control data types; and
storing in the security object temporal security control data for each user-selected temporal security control data type.

3. The method of temporal control of access to a resource according to claim 1 wherein:
the temporal security control data comprises a maximum allowable number of invocations of the security object,
the temporal security request data comprises a count of invocations of the security object, and
determining access to the resource in dependence upon the temporal security control data and the temporal security request data further comprises:
comparing the maximum allowable number of invocations and the count of invocations;
incrementing the count of invocations in dependence upon whether the maximum allowable number of invocations is greater than the count of invocations; and
granting access to the resource in dependence upon whether the maximum allowable number of invocations is greater than the count of invocations.

4. The method of temporal control of access to a resource according to claim 1 wherein:
the temporal security control data comprises a starting validity time and an ending validity time, the starting validity time and the ending validity time defining a validity period for the security object,
the temporal security request data comprises a time when the security object is invoked, and
determining access to the resource in dependence upon the temporal security control data and the temporal security request data further comprises:
determining whether the time when the security object is invoked is within the validity period;
granting access to the resource in dependence upon whether the time when the security object is invoked is within the validity period.

5. The method of temporal control of access to a resource according to claim 1 wherein:
the temporal security control data comprises a maximum allowable number of invocations of the security object during a throttle period, a throttle start time and throttle duration, the throttle start time and the throttle duration defining the throttle period,
the temporal security request data comprises a time when the security object is invoked and a count of invocations of the security object during the throttle period, and
determining access to the resource in dependence upon the temporal security control data and the temporal security request data further comprises:
determining whether the time when the security object is invoked is within the throttle period; and
optionally determining whether the count of invocations is less than the maximum allowable number of invocations; and
determining access to the resource in dependence upon whether the time when the security object is invoked is within the throttle period and optionally upon whether the count of invocations is less than the maximum allowable number of invocations.

6. The method of temporal control of access to a resource according to claim 5 wherein determining whether the time when the security object is invoked is within the throttle period results in a determination that the time when the security object is invoked is within the throttle period, the method further comprising:
determining whether the maximum allowable number of invocations is greater than the count of invocations, resulting in a determination that the count of invocations is less than the maximum allowable number of invocations during the throttle period;
incrementing the count of invocations; and
granting access to the resource.

7. The method of temporal control of access to a resource according to claim 5 wherein determining whether the time when the security object is invoked is within the throttle period results in a determination that the time when the security object is invoked is past the throttle period, the method further comprising:
setting the count of invocations during the throttle period to one;
setting the throttle start time to the time when the security object is invoked; and
granting access to the resource.

8. The method of temporal control of access to a resource according to claim 5 wherein determining whether the time when the security object is invoked is within the throttle period results in a determination that the time when the security object is invoked is within the throttle period, the method further comprising:
determining whether the maximum allowable number of invocations is greater than the count of invocations, resulting in a determination that the count of invocations is at least equal to the maximum allowable number of invocations during the throttle period; and
denying access to the resource.

9. The method of temporal control of access to a resource according to claim 1 wherein:
the temporal security control data comprises a minimum allowable number of invocations of the security object during a threshold period, a threshold start time and threshold duration, the threshold start time and the threshold duration defining the threshold period,
the temporal security request data comprises a time when the security object is invoked and a count of invocations of the security object during the threshold period, and
determining access to the resource in dependence upon the temporal security control data and the temporal security request data further comprises:
determining whether the time when the security object is invoked is within the threshold period;
optionally determining whether the count of invocations is at least equal to the minimum allowable number of invocations during the threshold period; and
determining access to the resource in dependence upon whether the time when the security object is invoked is within the threshold period and optionally upon whether the count of invocations is at least equal to the minimum allowable number of invocations during the threshold period.

10. The method of temporal control of access to a resource according to claim 9 wherein determining whether the time when the security object is invoked is within the threshold period results in a determination that the time when the security object is invoked is within the threshold period, the method further comprising:
incrementing the count of invocations; and
granting access to the resource.

11. The method of temporal control of access to a resource according to claim 9 wherein determining whether the time when the security object is invoked is within the threshold period results in a determination that the time when the security object is invoked is after the threshold period, the method further comprising:
determining whether the count of invocations is at least equal to the minimum allowable number of invocations during the threshold period, resulting in a determination that the count of invocations is at least equal to the minimum allowable number of invocations during the threshold period;
setting the count of invocations during the threshold period to one;
setting the threshold period start time to the time when the security object is invoked; and
granting access to the resource.

12. The method of temporal control of access to a resource according to claim 9 wherein determining whether the time when the security object is invoked is within the threshold period results in a determination that the time when the security object is invoked is after the threshold period, the method further comprising:
determining whether the count of invocations is at least equal to the minimum allowable number of invocations during the threshold period, resulting in a determination that the count of invocations is less than the minimum allowable number of invocations during the threshold period; and
denying access to the resource.

13. The method of temporal control of access to a resource according to claim 1 wherein receiving a request for access to the resource comprises calling the security method.

14. The method of temporal control of access to a resource according to claim 1 wherein receiving a request for access to the resource further comprises identifying the security object.

15. The method of temporal control of access to a resource according to claim 14 wherein identifying the security object comprises identifying the security object in dependence upon a URI.

16. The method of temporal control of access to a resource according to claim 14 wherein identifying the security object comprises identifying the security object in dependence upon a URI that identifies the resource, including finding, in dependence upon the URI identifying the resource, an identification of the security object in an access control table.

17. A system for temporal control of access to a resource, the system comprising:
means for creating a security object in dependence upon user-selected temporal security control data types, the security object comprising temporal security control data and at least one security method;
means for receiving a request for access to the resource;
means for receiving temporal security request data; and
means for determining access to the resource in dependence upon the temporal security control data and the temporal security request data.

18. The system for temporal control of access to a resource according to claim 17 wherein means for creating a security object further comprises:
means for storing in the security object a resource identification for the resource;
means for storing in the security object user-selected temporal security control data types; and
means for storing in the security object temporal security control data for each user-selected temporal security control data type.

19. The system for temporal control of access to a resource according to claim 17 wherein:
the temporal security control data comprises a maximum allowable number of invocations of the security object,
the temporal security request data comprises a count of invocations of the security object, and
means for determining access to the resource in dependence upon the temporal security control data and the temporal security request data further comprises:
means for comparing the maximum allowable number of invocations and the count of invocations;
means for incrementing the count of invocations in dependence upon whether the maximum allowable number of invocations is greater than the count of invocations; and
means for granting access to the resource in dependence upon whether the maximum allowable number of invocations is greater than the count of invocations.

20. The system for temporal control of access to a resource according to claim 17 wherein:
the temporal security control data comprises a starting validity time and an ending validity time, the starting validity time and the ending validity time defining a validity period for the security object,
the temporal security request data comprises a time when the security object is invoked, and
means for determining access to the resource in dependence upon the temporal security control data and the temporal security request data further comprises:
means for determining whether the time when the security object is invoked is within the validity period;
means for granting access to the resource in dependence upon whether the time when the security object is invoked is within the validity period.

21. The system for temporal control of access to a resource according to claim 17 wherein:
the temporal security control data comprises a maximum allowable number of invocations of the security object during a throttle period, a throttle start time and throttle duration, the throttle start time and the throttle duration defining the throttle period,
the temporal security request data comprises a time when the security object is invoked and a count of invocations of the security object during the throttle period, and
means for determining access to the resource in dependence upon the temporal security control data and the temporal security request data further comprises:
means for determining whether the time when the security object is invoked is within the throttle period; and
means for optionally determining whether the count of invocations is less than the maximum allowable number of invocations; and
means for determining access to the resource in dependence upon whether the time when the security object is invoked is within the throttle period and optionally upon whether the count of invocations is less than the maximum allowable number of invocations.

22. The system for temporal control of access to a resource according to claim 21 wherein means for determining whether the time when the security object is invoked is within the throttle period results in a determination that the time when the security object is invoked is within the throttle period, the system further comprising:
means for determining whether the maximum allowable number of invocations is greater than the count of invocations, resulting in a determination that the count of invocations is less than the maximum allowable number of invocations during the throttle period;
means for incrementing the count of invocations; and
means for granting access to the resource.

23. The system for temporal control of access to a resource according to claim 21 wherein means for determining whether the time when the security object is invoked is within the throttle period results in a determination that the time when the security object is invoked is past the throttle period, the system further comprising:
means for setting the count of invocations during the throttle period to one;
means for setting the throttle start time to the time when the security object is invoked; and
means for granting access to the resource.

24. The system for temporal control of access to a resource according to claim 21 wherein means for determining whether the time when the security object is invoked is within the throttle period results in a determination that the time when the security object is invoked is within the throttle period, the system further comprising:
means for determining whether the maximum allowable number of invocations is greater than the count of invocations, resulting in a determination the count of invocations is at least equal to the maximum allowable number of invocations during the throttle period; and
means for denying access to the resource.

25. The system for temporal control of access to a resource according to claim 17 wherein:
the temporal security control data comprises a minimum allowable number of invocations of the security object during a threshold period, a threshold start time and threshold duration, the threshold start time and the threshold duration defining the threshold period,
the temporal security request data comprises a time when the security object is invoked and a count of invocations of the security object during the threshold period, and
means for determining access to the resource in dependence upon the temporal security control data and the temporal security request data further comprises:
means for determining whether the time when the security object is invoked is within the threshold period;
means for optionally determining whether the count of invocations is at least equal to the minimum allowable number of invocations during the threshold period; and
means for determining access to the resource in dependence upon whether the time when the security object is invoked is within the threshold period and optionally upon whether the count of invocations is at least equal to the minimum allowable number of invocations during the threshold period.

26. The system for temporal control of access to a resource according to claim 25 wherein means for determining whether the time when the security object is invoked is within the threshold period results in a determination that the time when the security object is invoked is within the threshold period, the system further comprising:
means for incrementing the count of invocations; and
means for granting access to the resource.

27. The system for temporal control of access to a resource according to claim 25 wherein means for determining whether the time when the security object is invoked is within the threshold period results in a determination that the time when the security object is invoked is after the threshold period, the system further comprising:
means for determining whether the count of invocations is at least equal to the minimum allowable number of invocations during the threshold period, resulting in a determination that the count of invocations is at least equal to the minimum allowable number of invocations during the threshold period;
means for setting the count of invocations during the threshold period to one;
means for setting the threshold period start time to the time when the security object is invoked; and
means for granting access to the resource.

28. The system for temporal control of access to a resource according to claim 25 wherein means for determining whether the time when the security object is invoked is within the threshold period results in a determination that the time when the security object is invoked is after the threshold period, the system further comprising:
means for determining whether the count of invocations is at least equal to the minimum allowable number of invocations during the threshold period, resulting in a determination that the count of invocations is less than the minimum allowable number of invocations during the threshold period; and
means for denying access to the resource.

29. The system for temporal control of access to a resource according to claim 17 wherein means for receiving a request for access to the resource comprises means for calling the security method.

30. The system for temporal control of access to a resource according to claim 17 wherein means for receiving a request for access to the resource further comprises means for identifying the security object.

31. The system for temporal control of access to a resource according to claim 30 wherein means for identifying the security object comprises means for identifying the security object in dependence upon a URI.

32. The system for temporal control of access to a resource according to claim 30 wherein means for identifying the security object comprises means for identifying the security object in dependence upon a URI that identifies the resource, including finding, in dependence upon the URI identifying the resource, an identification of the security object in an access control table.

33. A computer program. product for temporal control of access to a resource, the computer program product comprising:
a recording medium;
means, recorded on the recording medium, for creating a security object in dependence upon user-selected temporal security control data types, the security object comprising temporal security control data and at least one security method;
means, recorded on the recording medium, for receiving a request for access to the resource;
means, recorded on the recording medium, for receiving temporal security request data; and
means, recorded on the recording medium, for determining access to the resource in dependence upon the temporal security control data and the temporal security request data.

34. The computer program product for temporal control of access to a resource according to claim 33 wherein means, recorded on the recording medium, for creating a security object further comprises:
means, recorded on the recording medium, for storing in the security object a resource identification for the resource;
means, recorded on the recording medium, for storing in the security object user-selected temporal security control data types; and
means, recorded on the recording medium, for storing in the security object temporal security control data for each user-selected temporal security control data type.

35. The computer program product for temporal control of access to a resource according to claim 33 wherein:
the temporal security control data comprises a maximum allowable number of invocations of the security object,
the temporal security request data comprises a count of invocations of the security object, and
means, recorded on the recording medium, for determining access to the resource in dependence upon the temporal security control data and the temporal security request data further comprises:
means, recorded on the recording medium, for comparing the maximum allowable number of invocations and the count of invocations;
means, recorded on the recording medium, for incrementing the count of invocations in dependence upon whether the maximum allowable number of invocations is greater than the count of invocations; and
means, recorded on the recording medium, for granting access to the resource in dependence upon whether the maximum allowable number of invocations is greater than the count of invocations.

36. The computer program product for temporal control of access to a resource according to claim 33 wherein:
the temporal security control data comprises a starting validity time and an ending validity time, the starting validity time and the ending validity time defining a validity period for the security object,
the temporal security request data comprises a time when the security object is invoked, and
means, recorded on the recording medium, for determining access to the resource in dependence upon the temporal security control data and the temporal security request data further comprises:
means, recorded on the recording medium, for determining whether the time when the security object is invoked is within the validity period;
means, recorded on the recording medium, for granting access to the resource in dependence upon whether the time when the security object is invoked is within the validity period.

37. The computer program product for temporal control of access to a resource according to claim 33 wherein:
the temporal security control data comprises a maximum allowable number of invocations of the security object during a throttle period, a throttle start time and throttle duration, the throttle start time and the throttle duration defining the throttle period,
the temporal security request data comprises a time when the security object is invoked and a count of invocations of the security object during the throttle period, and
means, recorded on the recording medium, for determining access to the resource in dependence upon the temporal security control data and the temporal security request data further comprises:
means, recorded on the recording medium, for determining whether the time when the security object is invoked is within the throttle period; and
means, recorded on the recording medium, for optionally determining whether the count of invocations is less than the maximum allowable number of invocations; and
means, recorded on the recording medium, for determining access to the resource in dependence upon whether the time when the security object is invoked is within the throttle period and optionally upon whether the count of invocations is less than the maximum allowable number of invocations.

38. The computer program product for temporal control of access to a resource according to claim 37 wherein means, recorded on the recording medium, for determining whether the time when the security object is invoked is within the throttle period results in a determination that the time when the security object is invoked is within the throttle period, the computer program product further comprising:
means, recorded on the recording medium, for determining whether the maximum allowable number of invocations is greater than the count of invocations, resulting in a determination that the count of invocations is less than the maximum allowable number of invocations during the throttle period;
means, recorded on the recording medium, for incrementing the count of invocations; and
means, recorded on the recording medium, for granting access to the resource.

39. The computer program product for temporal control of access to a resource according to claim 37 wherein means, recorded on the recording medium, for determining whether the time when the security object is invoked is within the throttle period results in a determination that the time when the security object is invoked past the throttle period, the computer program product further comprising:
means, recorded on the recording medium, for setting the count of invocations during the throttle period to one;
means, recorded on the recording medium, for setting the throttle start time to the time when the security object is invoked; and
means, recorded on the recording medium, for granting access to the resource.

40. The computer program product for temporal control of access to a resource according to claim 37 wherein means, recorded on the recording medium, for determining whether the time when the security object is invoked is within the throttle period results in a determination that the time when the security object is invoked is within the throttle period, the computer program product further comprising:
means, recorded on the recording medium, for determining whether the maximum allowable number of invocations is greater than the count of invocations, resulting in a determination the count of invocations is at least equal to the maximum allowable number of invocations during the throttle period; and
means, recorded on the recording medium, for denying access to the resource.

41. The computer program product for temporal control of access to a resource according to claim 33 wherein:
the temporal security control data comprises a minimum allowable number of invocations of the security object during a threshold period, a threshold start time and threshold duration, the threshold start time and the threshold duration defining the threshold period,
the temporal security request data comprises a time when the security object is invoked and a count of invocations of the security object during the threshold period, and
means, recorded on the recording medium, for determining access to the resource in dependence upon the temporal security control data and the temporal security request data further comprises:
means, recorded on the recording medium, for determining whether the time when the security object is invoked is within the threshold period;
means, recorded on the recording medium, for optionally determining whether the count of invocations is at least equal to the minimum allowable number of invocations during the threshold period; and
means, recorded on the recording medium, for determining access to the resource in dependence upon whether the time when the security object is invoked is within the threshold period and optionally upon whether the count of invocations is at least equal to the minimum allowable number of invocations during the threshold period.

42. The computer program product for temporal control of access to a resource according to claim 41 wherein means, recorded on the recording medium, for determining whether the time when the security object is invoked is within the threshold period results in a determination that the time when the security object is invoked is within the threshold period, the computer program product further comprising:
means, recorded on the recording medium, for incrementing the count of invocations; and
means, recorded on the recording medium, for granting access to the resource.

43. The computer program product for temporal control of access to a resource according to claim 41 wherein means, recorded on the recording medium, for determining whether the time when the security object is invoked is within the threshold period results in a determination that the time when the security object is invoked is after the threshold period, the computer program product further comprising:
means, recorded on the recording medium, for determining whether the count of invocations is at least equal to the minimum allowable number of invocations during the threshold period, resulting in a determination that the count of invocations is at least equal to the minimum allowable number of invocations during the threshold period;
means, recorded on the recording medium, for setting the count of invocations during the threshold period to one;
means, recorded on the recording medium, for setting the threshold period start time to the time when the security object is invoked; and
means, recorded on the recording medium, for granting access to the resource.

44. The computer program product for temporal control of access to a resource according to claim 41 wherein means, recorded on the recording medium, for determining whether the time when the security object is invoked is within the threshold period results in a determination that the time when the security object is invoked is after the threshold period, the computer program product further comprising:
means, recorded on the recording medium, for determining whether the count of invocations is at least equal to the minimum allowable number of invocations during the threshold period, resulting in a determination that the count of invocations is less than the minimum allowable number of invocations during the threshold period; and
means, recorded on the recording medium, for denying access to the resource.

45. The computer program product for temporal control of access to a resource according to claim 33 wherein means, recorded on the recording medium, for receiving a request for access to the resource comprises means for calling the security method.

46. The computer program product for temporal control of access to a resource according to claim 33 wherein means, recorded on the recording medium, for receiving a request for access to the resource further comprises means, recorded on the recording medium, for identifying the security object.

47. The computer program product for temporal control of access to a resource according to claim 46 wherein means, recorded on the recording medium, for identifying the security object comprises means, recorded on the recording medium, for identifying the security object in dependence upon a URI.

48. The computer program product for temporal control of access to a resource according to claim 46 wherein means, recorded on the recording medium, for identifying the security object comprises means for identifying the security object in dependence upon a URI that identifies the resource, including finding, in dependence upon the URI identifying the resource, an identification of the security object in an access control table.
